(19) United States
(12) Patent Application Publication
(10) Pub. No.: US 2011/0260124 A1
(43) Pub. Date: Oct. 27, 2011

(54) ALKALI METAL ION-DOPED ELECTROCHROMIC FILMS AND METHODS OF MAKING THE SAME

(75) Inventors: Dane Gillaspie, Golden, CO (US); Robert C. Tenent, Golden, CO (US)

(73) Assignee: Alliance for Sustainable Energy, LLC, Golden, CO (US)

(21) Appl. No.: 12/766,049

(22) Filed: Apr. 23, 2010

(51) Int. Cl. G02B 5/23; B05D 5/06

(52) U.S. Cl. 252/586; 427/523

(57) ABSTRACT

Alkali metal ion-doped electrochromic films, and methods of making such films, are disclosed. An exemplary electrochromic film comprises a lattice of an oxide of a Group VIII transition metal and a dopant deposited onto the surface of a substrate. The oxide is generated by heating at least one starting material and at least one dopant ion source on the surface of the substrate.

The United States Government has rights in this invention under Contract No. DE-AC36-08GO28308 between the United States Department of Energy and the Alliance for Sustainable Energy, LLC, the Manager and Operator of the National Renewable Energy Laboratory.

### BACKGROUND

The internal environmental control of buildings is responsible for a significant portion of overall electricity use in the United States. Energy-efficient, or “smart,” windows that can change transmission characteristics in response to external stimuli can make a tremendous impact on this use by reducing the total amount of energy needed to maintain comfortable building environments, as well as by providing controllable daylighting for building occupants.

One method to accomplish this is to employ electrochromic metal oxide films with building windows, where the optical transmission through the window may be modulated to pass or block incident sunlight by applying a small voltage. Tungsten oxide (WO₃) shows cathodic coloration with electron injection and charge-balancing ion insertion.

It is therefore possible to combine an electrode that exhibits cathodic coloration with a counter-electrode that displays anodic coloration to fabricate an electrochromic device. One such electrochromic device uses WO₃ as the active, cathodic, electrode and nickel oxide (NiO) as the counter, anodic, electrode. Although NiO has been shown to act successfully as a counter-electrode for the WO₃ system in these studies, ion movement into and out of the NiO structure is slower than for WO₃, thereby limiting the switching speed and overall device performance.

Additionally, widespread implementation of “smart” windows requires the development of cost-effective manufacturing techniques that can be integrated into large-scale manufacturing. Presently, electrochromic, metal oxide films are typically deposited by vacuum deposition methods, primarily sputtering, although several alternate processes have been demonstrated.

The foregoing examples of the related art and limitations related therewith are intended to be illustrative and not exclusive. Other limitations of the related art will become apparent to those of skill in the art upon a reading of the specification and a study of the drawings.

### SUMMARY

Thus, alkali metal ion-doped NiO electrochromic films that may be produced by cost-effective techniques are useful. The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In various aspects, electrochromic films having a lattice of an oxide of a Group VIII transition metal and a dopant deposited onto the surface of a substrate, wherein the oxide is generated by heating at least one starting material and at least one dopant ion source on the surface of the substrate, are disclosed.

In some embodiments, the oxide is selected from oxides of Group VIII transition metals including, for example, iron oxide, cobalt oxide, nickel oxide, ruthenium oxide, rhodium oxide, palladium oxide, osmium oxide, iridium oxide, platinum oxide and combinations of the foregoing. In some embodiments, the oxide is nickel oxide.

In some embodiments, the dopant is selected from ions of alkali metals including, for example, hydrogen ions, lithium ions, sodium ions, potassium ions, rubidium ions, caesium ions, francium ions, and combinations of the foregoing. In some embodiments, the dopant comprises lithium ions.

In some embodiments, the at least one starting material and at least one dopant ion source are heated on the surface at a temperature of from about 300° C. to about 350° C.

In some embodiments, the at least one starting material is selected from nitrates of Group VIII transition metals including, for example, iron nitrate, cobalt nitrate, nickel nitrate, ruthenium nitrate, rhodium nitrate, palladium nitrate, osmium nitrate, iridium nitrate, platinum nitrate and combinations thereof. In some embodiments, the at least one starting material is nickel nitrate.

In some embodiments, the at least one dopant ion source is selected from nitrates of alkali metals including, for example, nitric acid, lithium nitrate, sodium nitrate, potassium nitrate, rubidium nitrate, caesium nitrate, francium nitrate, and combinations thereof. In some embodiments, the at least one dopant ion source is lithium nitrate.

In some embodiments, the at least one starting material is nickel nitrate and the at least one dopant ion source is lithium nitrate. In such embodiments, the nickel nitrate and the lithium nitrate are heated on the surface of the substrate at about 330° C.

In some embodiments, the lattice is selected from completely crystalline, completely amorphous, and partially amorphous/partially crystalline. In certain embodiments, the lattice is partially amorphous/partially crystalline and comprises crystallites, or small crystals, of the oxide of the Group VIII transition metal.

In various aspects, the electrochromic films of the present disclosure color anodically, not cathodically, and can thus be used as counter electrodes to cathodically coloring electrochromic films such as, for example, WO₃ electrochromic films.

In various aspects, methods of making electrochromic films of the present disclosure are disclosed.

In some embodiments, the methods comprise introducing a precursor solution into an ultrasonic spray deposition system, wherein the precursor solution comprises at least one starting material and at least one dopant ion source, wherein the spray deposition system comprises a spray head, and wherein the spray head comprises a tip surface and a spray orifice.

In some embodiments, the methods further comprise applying an ultrasonic frequency to the spray head to ultrasonically excite the tip surface.

In some embodiments, the methods further comprise pumping the precursor solution to the ultrasonically excited tip surface.

In some embodiments, the methods further comprise generating standing waves in the liquid precursor solution on the tip surface.

In some embodiments, the methods further comprise generating atomized droplets of the liquid precursor solution on the tip surface.

In some embodiments, the methods further comprise moving the atomized droplets from the spray orifice to a heated substrate surface by a controlled flow of gas.

In some embodiments, the methods further comprise heating the atomized droplets on the substrate surface to generate the electrochromic film.

In some embodiments, the at least one starting material is selected from nitrates of Group VIII transition metals including, for example, iron nitrate, cobalt nitrate, nickel nitrate, ruthenium nitrate, rhodium nitrate, palladium nitrate, osmium nitrate, iridium nitrate, platinum nitrate and combinations thereof.

In some embodiments, the at least one dopant ion source is selected from nitrates of alkali metals including, for example, nitric acid, lithium nitrate, sodium nitrate, potassium nitrate, rubidium nitrate, caesium nitrate, francium nitrate, and combinations thereof.

In some embodiments, the ultrasonic frequency applied to the spray head to ultrasonically excite the tip surface ranges from about 110 kHz to about 130 kHz.

In some embodiments, the gas in the controlled flow of gas that moves the atomized droplets from the spray orifice to a heated substrate surface, is nitrogen.

In some embodiments, the at least one starting material is nickel nitrate, the at least one dopant ion source is lithium nitrate, and the heating of the nickel nitrate and the lithium nitrate is performed on the surface of the substrate at about 330° C.

In various aspects, electrochromic films comprising a lithium ion-doped nickel oxide lattice deposited onto the surface of a substrate are disclosed.

In some embodiments, the nickel oxide is generated by heating 95 wt % nickel nitrate and 5 wt % lithium nitrate to 330° C. on the surface of the substrate.

In some embodiments, the lattice comprises an amorphous lithium-nickel-oxide matrix comprising nickel oxide crystallites.

In some embodiments, the electrochromic films comprising a lithium ion-doped nickel oxide lattice deposited onto the surface of a substrate color anodically.

In addition to the exemplary aspects and embodiments described above, further aspects and embodiments will become apparent by reference to the drawings and by study of the following descriptions

### BRIEF DESCRIPTION OF THE DRAWINGS

Those skilled in the art will understand that the drawings, described herein, are for illustration purposes only. The drawings are not intended to limit the scope of the present disclosure.

FIG. 1 shows thermogravametric data for NiNO₃ and LiNO₃ under a pseudo air mixture.

FIG. 2A shows X-ray diffraction data for an embodiment of an as-deposited electrochromic film of the present disclosure sprayed from NiNO₃ both with, and without, LiNO₃ added.

FIG. 2B shows Raman spectroscopy data for an embodiment of an as-deposited electrochromic film of the present disclosure sprayed from NiNO₃ both with, and without, LiNO₃ added.

FIG. 3A shows cyclic voltammetry data for an embodiment of an electrochromic film of the present disclosure spray coated from NiNO₃ with LiNO₃ present. FIG. 3B shows cyclic voltammetry data for an embodiment of an electrochromic film of the present disclosure spray coated from NiNO₃ without LiNO₃ present. The vertical axes for both FIG. 3A and FIG. 3B are the same. The vertical axes in the center have been deleted.

FIG. 4A shows the optical transmission response from the electrochromic films of FIGS. 3A and 3B under an electrical potential step-cycling between 4.25V and 2.25 V vs. Li/Li+.

FIG. 4B shows the normalized optical transmission response from the electrochromic films of FIGS. 3A and 3B as a function of time, extracted from one cycle of the data shown in FIG. 4A. Transmission was normalized to the final transmission obtained after 5 minutes at potential.

FIG. 5A shows cyclic voltammetry for an embodiment of a lithium-doped nickel oxide film of the present disclosure sprayed from differing precursor concentrations.

FIG. 5B shows a scanning electron micrograph image of an embodiment of a lithium-doped nickel oxide film of the present disclosure sprayed from 10 mM NiNO₃, with 5 wt % LiNO₃ added.

FIG. 5C shows a scanning electron micrograph image of an embodiment of a lithium-doped nickel oxide film of the present disclosure sprayed from 1M NiNO₃, with 5 wt % LiNO₃ added.

FIGS. 6A and 6B show cyclic voltammetry data for an electrochromic film spray coated from NiNO₃ as compared to an electrochromic film spray coated from NiNO₃ with 5 wt % LiCl present as a dopant.

### DETAILED DESCRIPTION

Reference is now made in detail to certain embodiments of lithium-doped nickel oxide electrochromic films. The disclosed embodiments are not intended to be limiting of the claims. To the contrary, the claims are intended to cover all alternatives, modifications, and equivalents.

In several aspects, the present disclosure relates to nickel oxide (NiO) electrochromic films comprising one or more alkali metal ion sources as dopants. In some aspects, the present disclosure relates to nickel oxide (NiO) electrochromic films comprising an alkali metal ion source as a dopant. In some embodiments, the alkali metal ion is selected from one or more of the chemical elements forming Group 1 of the IUPAC-type periodic table of the elements. In some embodiments, the alkali metal ion is selected from hydrogen, lithium, sodium, potassium, rubidium, caesium, and francium. In some embodiments, the alkali metal ion is lithium. In some embodiments, the alkali metal ion source is selected from nitric acid (HNO₃), lithium nitrate (LiNO₃), sodium nitrate (NaNO₃), potassium nitrate (KNO₃), rubidium nitrate (RbNO₃), caesium nitrate (CsNO₃), and francium nitrate (FrNO₃). In some embodiments, the alkali metal ion source is lithium nitrate (LiNO₃).

In several aspects, NiO electrochromic films of the present disclosure color anodically. In some embodiments, NiO electrochromic films of the present disclosure are useful as electrochromic counter electrodes. In some embodiments, NiO electrochromic films of the present disclosure are useful as counter electrodes for electrochromic applications that utilize tungsten oxide (WO₃) cathodes. Examples of electrochromic applications that utilize tungsten oxide (WO₃) cathodes include, without limitation, smart windows, computer displays, electric paper, eyewear, variable emissivity thermal control devices, variable mirrors, car mirrors, motorcycle helmet visors, and ski goggles, among others.

In several aspects, the coloration switching speed, or the speed at which the films switch between a colored and a non-colored state, of the alkali metal-doped NiO electrochromic films of the present disclosure is comparable to reported coloration switching speed measurements for electrochromic films made from WO₃. In some embodiments, the coloration switching speed of lithium-doped NiO electrochromic films of the present disclosure is comparable to reported coloration switching speed measurements for electrochromic films made from WO₃. In some embodiments, lithium-doped NiO electrochromic films of the present disclosure achieve at least about 90% of their total coloration change in about 29 seconds, which is comparable to reported coloration measurements for electrochromic films made from WO₃. This represents an improvement over NiO materials which are slow to color when compared to WO₃ and may thereby limit the overall response time of an electrochromic film comprising tandem NiO anodes/WO₃ cathodes.

In several aspects, low-cost, high-throughput deposition methods for making alkali metal-doped NiO electrochromic films that demonstrate improved electrochromic performance are disclosed. In some embodiments, the methods are based on ultrasonic spray deposition of aqueous-based precursor solutions in air at atmospheric pressure. In some embodiments, the methods comprise ultrasonic spray deposition methods where: a liquid precursor solution is pumped to an ultrasonically excited nozzle or tip surface; standing waves form in the liquid precursor solution on the nozzle or tip surface which become unstable at their peaks and collapse, leading to the generation of fine and/or atomized droplets of the liquid precursor solution; and the fine and/or atomized droplets are carried, by a controlled nitrogen flow, to a heated substrate where they undergo thermal decomposition to yield the desired film on the surface of the substrate. In some embodiments, the disclosed methods represent significant cost savings as compared to vacuum deposition methods.

Electrochromic devices, such as electrochromic films, change light transmission properties in response to voltage and thus regulate or alter the amount of light and/or heat passing through such devices. When utilized with glass devices such as windows, electrochromic devices can be configured to change their opacity between a colored state and a transparent state. An electrical current is typically required for an electrochromic device to change its opacity. Coloration typically occurs from the edges, moving inward, and may take seconds to minutes to complete, depending on the size of the electrochromic device. Electrochromic devices utilized with glass can be configured to provide visibility through the glass even in the colored state, thus preserving visible contact with the outside environment, or may be configured to completely block visibility through the glass. Electrochromic devices are useful in many applications including, for example, windows, rearview mirrors, protection of objects under glass, picture frame glass, and similar applications.

Electrochromic devices can be deposited directly onto a substrate where they will elicit their colored effect. For example, electrochromic films can be deposited directly onto a

[symbol]

Some electrochromic materials color cathodically by the insertion of electrons and positive ions. Examples of transition metals suitable for generation of cathodic coloring electrochromic films include, without limitation, chromium, molybdenum, and tungsten. Tungsten oxide (WO₃) shows cathodic coloration with electron injection and charge-balancing ion insertion.

Alternately, some electrochromic materials color anodically by the removal of electrons and positive ions. Examples of materials suitable for generation of anodic coloring electrochromic films include, without limitation, nickel oxide and iridium oxide.

In various aspects, the present disclosure relates to anodically coloring electrochromic materials. In some embodiments, the anodically coloring electrochromic materials are electrochromic films.

In some embodiments, the anodically coloring electrochromic materials are electrochromic films deposited onto a substrate surface. The films can comprise any one or more materials that display anodic coloration including, without limitation, oxides of Group VIII transition metals such as, for example, iron oxide, cobalt oxide, nickel oxide, ruthenium oxide, rhodium oxide, palladium oxide, osmium oxide, iridium oxide, and platinum oxide. In some embodiments, the materials comprising the electrochromic films comprise crystalline nickel oxide (NiO). In some embodiments, the materials comprising the electrochromic films comprise amorphous nickel oxide (NiO). In some embodiments, the materials comprising the electrochromic films comprise both crystalline and amorphous nickel oxide (NiO).

In some embodiments, the electrochromic films of the present disclosure comprise one or more starting materials deposited onto the surface of a substrate. The starting materials can be deposited onto the substrate surface using any number of means including, for example, vacuum deposition such as sputtering. In some embodiments, the starting materials are deposited onto the surface of a substrate by the methods disclosed hereinbelow. After deposition onto the surface of a substrate, the starting materials can be allowed to dry, forming a lattice of the starting materials. In some embodiments, the lattice is crystalline. In some embodiments the lattice is amorphous. In some embodiments, the lattice comprises both amorphous and crystalline elements.

In some embodiments, the starting materials comprise nitrates of one or more of the Group VIII transition metals. In some embodiments, the starting materials comprise a nitrate of one or more of iron, cobalt, nickel, ruthenium, rhodium, palladium, osmium, iridium, and platinum. In some embodiments, the starting materials comprise nickel nitrate (NiNO₃).

In some embodiments, the lattice comprises oxides of any one or more of the Group VIII transition metals such as, for example, iron oxide, cobalt oxide, nickel oxide, ruthenium oxide, rhodium oxide, palladium oxide, osmium oxide, iridium oxide, and platinum oxide. In some embodiments, the lattice comprises nickel oxide (NiO).

In various aspects, the anodically coloring electrochromic materials are electrochromic films comprising one or more starting materials and a dopant. In several aspects, the electrochromic films of the present disclosure comprise one or more starting materials deposited onto the surface of a substrate. The starting materials can be deposited onto the substrate surface using any number of means including, for example, vacuum deposition such as sputtering. In some embodiments, the starting materials are deposited onto the surface of a substrate by the methods disclosed hereinbelow. After deposition onto the surface of a substrate, the starting materials can be allowed to dry, forming a lattice of the starting materials. In some embodiments, the lattice is crystalline. In some embodiments the lattice is amorphous. In some embodiments, the lattice comprises both amorphous and crystalline elements.

In some embodiments, the starting materials comprise nitrates of one or more of the Group VIII transition metals and one or more dopants. In some embodiments, the starting materials comprise a nitrate of one or more of iron, cobalt, nickel, ruthenium, rhodium, palladium, osmium, iridium, and platinum and one or more dopants. In some embodiments, the starting materials comprise NiNO₃ and one or more dopants. In some embodiments, the one or more dopants comprise one or more alkali metal ions. In some embodiments, the one or more alkali metal ions are provided by one or more alkali metal ion sources. In some embodiments, the alkali metal ion is selected from hydrogen, lithium, sodium, potassium, rubidium, caesium, and francium. In some embodiments, the alkali metal ion is lithium. In some embodiments, the alkali metal ion source is selected from nitrates of one or more alkali metal ions. In some embodiments, the alkali metal ion source is selected from nitric acid (HNO₃), lithium nitrate (LiNO₃), sodium nitrate (NaNO₃), potassium nitrate (KNO₃), rubidium nitrate (RbNO₃), caesium nitrate (CsNO₃), and francium nitrate (FrNO₃). In some embodiments, the alkali metal ion source is lithium nitrate (LiNO₃).

In some embodiments, the lattice comprises alkali metal ion-doped oxides of any one or more of the Group VIII transition metals such as, for example, iron oxide, cobalt oxide, nickel oxide, ruthenium oxide, rhodium oxide, palladium oxide, osmium oxide, iridium oxide, and platinum oxide. In some embodiments, the lattice comprises alkali metal ion doped NiO. In some embodiments, the lattice comprises lithium ion-doped NiO.

In various aspects, the anodically coloring electrochromic materials are electrochromic films comprising starting materials, wherein the starting materials comprise NiNO₃ and LiNO₃. In several aspects, the electrochromic films of the present disclosure comprise starting materials comprising NiNO₃ and LiNO₃ deposited onto the surface of a substrate. The starting materials comprising NiNO₃ and LiNO₃ can be deposited onto the substrate surface using any number of means including, for example, vacuum deposition such as sputtering. In some embodiments, the starting materials comprising NiNO₃ and LiNO₃ are deposited onto the surface of a substrate by the methods disclosed hereinbelow. After deposition onto the surface of a substrate, the starting materials comprising NiNO₃ and LiNO₃ can be allowed to dry, forming a lattice of the starting materials. In some embodiments, the lattice is crystalline. In some embodiments the lattice is amorphous. In some embodiments, the lattice comprises both amorphous and crystalline elements. In some embodiments, the lattice comprises lithium ion-doped NiO. In some embodiments, the lattice comprises an amorphous LiNiO matrix that comprises NiO crystals and/or crystallites.

In certain embodiments, electrochromic films of the present disclosure comprising NiNO₃ and LiNO₃ exhibit characteristic scattering angles at 32.25°±0.25°, 35.45°±0.25°, 37.30°±0.25°, and 43.50°±0.25° with corresponding intensities, in Lin Counts, of 4,268.244141, 3,310.153809, 6,621.833984, and 15,335.60645, respectively, in an X-ray powder diffractogram using Cu Ka radiation.

A NiO lattice has been shown to act successfully as a counter, or anodic, electrode for a WO₃ cathode. However, ion movement into and out of the NiO lattice has been shown to be slower than for WO₃, thereby decreasing the rate of color change such electrochromic devices can achieve and thus the overall performance of such electrochromic devices. In various aspects, the anodically coloring electrochromic films of the present disclosure demonstrate improved kinetics. In some embodiments, anodically coloring electrochromic films of the present disclosure comprising lithium-doped NiO demonstrate improved coloring kinetics. In some embodiments, anodically coloring electrochromic films of the present disclosure comprising lithium-doped NiO demonstrate ion movement into and out of the NiO lattice that is similar to that for WO₃. Therefore, anodically coloring electrochromic films of the present disclosure comprising lithium-doped NiO are useful as counter, or anodic, electrodes in electrochromic devices employing WO₃ as the active, or cathodic, electrode.

A dopant is an impurity element that is added to a lattice, typically in low to moderate concentrations, to alter the optical and/or electrical properties of the materials comprising the lattice. A dopant works by altering the number of free electrons available in a lattice, thereby making it more electrically conductive. For example, certain elements or compounds can be dried to form a uniform, crystalline lattice in which each atom bonds to an equal number of neighboring atoms. When a dopant with an excess, for example 5, of bonding electrons is introduced, the result is free electrons present in the crystalline lattice, creating a negative charge. A dopant having three bonding electrons may be introduced to make holes in a lattice, creating a positive charge.

Depending upon the concentration of added dopant, the dopant may or may not interfere with the formation of the lattice. At very low concentrations, for example at below about 4%, the presence of a dopant may not substantially interfere with the formation of a lattice and thus allow the lattice to become completely crystalline. At low- to moderate concentrations, for example at about 4% to about 8%, a dopant may sufficiently interfere with the creation of the lattice so that the overall lattice is amorphous, with some crystals and/or crystallites remaining in the lattice. At high concentrations, for example at above 8%, a dopant may completely interfere with the creation of the lattice such that the lattice is completely amorphous.

In some embodiments, the amount of dopant added to the starting materials of the present disclosure ranges from about 1% to about 10% by weight of the total weight of the starting materials, in some embodiments from about 2% to about 7% by weight, in some embodiments from about 4% to about 6% by weight, and in some embodiments the amount of dopant added is about 5% by weight. In some embodiments, the amount of dopant added is selected from greater than about 1 wt %, greater than about 2 wt %, greater than about 3 wt %, greater than about 4 wt %, greater than about 5 wt %, greater than about 6 wt %, greater than about 7 wt %, greater than about 8 wt %, and greater than about 9 wt %. In some embodiments, the amount of dopant added is selected from less than about 10 wt %, less than about 9 wt %, less than about 8 wt %, less than about 7 wt %, less than about 6 wt %, less than about 5 wt %, less than about 4 wt %, less than about 3 wt %, and less than about 2 wt %. In some embodiments, the amount of dopant added is about 5 wt %.

In various aspects, the anodically coloring electrochromic materials of the present disclosure are electrochromic films comprising one or more starting materials (as defined above) and one or more dopants. In some embodiments, the one or more dopants comprise one or more alkali metal ions, whereby the one ore more alkali metal ions are the one or more dopants. In some embodiments, the one or more alkali metal ions, and thus the one or more dopants, are provided by one or more alkali metal ion sources. In some embodiments, the one or more alkali metal ions are selected from hydrogen ions, lithium ions, sodium ions, potassium ions, rubidium ions, caesium ions, and francium ions. In some embodiments, the alkali metal ion is lithium ion. In some embodiments, the alkali metal ion source is selected from nitrates of one or more alkali metal ions. In some embodiments, the alkali metal ion source is selected from nitric acid (HNO₃), lithium nitrate (LiNO₃), sodium nitrate (NaNO₃), potassium nitrate (KNO₃), rubidium nitrate (RbNO₃), caesium nitrate (CsNO₃), and francium nitrate (FrNO₃).

In some embodiments, the alkali metal ion is lithium and the alkali metal ion source is lithium nitrate (LiNO₃). In some embodiments, the anodically coloring electrochromic materials of the present disclosure are electrochromic films comprise NiO with a lithium ion dopant wherein the lithium ion source is LiNO₃. It has been reported that lithium ion based electrochromic devices that employ non-aqueous electrolytes have longer device lifetimes. It is therefore believed that anodically coloring electrochromic films comprising a lithium ion dopant will similarly experience longer device lifetimes.

Anodically coloring electrochromic films of the present disclosure are deposited onto the surface of a substrate. Such films can be deposited onto the substrate surface using any number of means including, for example, vacuum deposition such as sputtering, pressure-driven spraying methods, and gel processing.

In various aspects, the anodically coloring electrochromic films of the present disclosure are deposited onto the surface of a substrate via ultrasonic spray-coating deposition methods. In some embodiments, the spray-coating deposition methods can be performed using aqueous-based liquid precursor materials in air. The methods of the present disclosure represent significant improvements over other methods such as vacuum deposition methods, which require the equipment necessary to create a vacuum, or pressure driven deposition methods that require the equipment necessary to generate sufficient pressure to force particles through the air. Additionally, the methods of the present disclosure are more efficient than other methods and thus utilize lower amounts. In some embodiments, the methods of the present disclosure ultrasonically generate uniform droplets of the starting materials due to a narrower size distribution of droplets in the atomized material.

It is believed that the spray-coating deposition methods of the present disclosure will provide cost-effective means of producing the electrochromic films of the present disclosure, as well as other electrochromic films, such as WO₃ cathode films. Because the spray-coating deposition methods of the present disclosure do not require the creation of a vacuum, it is believed that such methods will be readily scalable to large scale manufacturing processes and can thus represent widely implementable production methods.

In some embodiments, the ultrasonic spray-coating deposition methods comprise a liquid precursor solution, comprising one or more starting materials as defined above and, in some embodiments, one or more dopants as defined above. In some embodiments, the liquid precursor solution comprises NiNO₃ and LiNO₃. The liquid precursor solution is introduced into an ultrasonic spray deposition system comprising a spray head that is configured to operate at one or more ultrasonic frequencies. In some embodiments, the spray head operates at a frequency of from about 90 kHz to about 150 kHz, in some embodiments of from about 100 kHz to about 140 kHz, in some embodiments of from about 110 kHz to about 130 kHz, and in some embodiments of from about 115 kHz to about 125 kHz. In some embodiments, the spray head operates at a frequency of about 120 kHz. An example of a suitable ultrasonic spray system includes, without limitation, a Sono-Tek Corporation (Milton, N.Y., U.S.A.) ultrasonic spray system comprising a Model 8700-120 spray head configured to operate at a frequency of about 120 kHz.

Once the liquid precursor solution is introduced into an ultrasonic spray deposition system, an ultrasonic generator may be used to apply any one or more of the ultrasonic frequencies disclosed above to the spray head of the ultrasonic spray deposition system. An example of a suitable ultrasonic generator includes, without limitation, a Sono-Tek Broad Band Ultrasonic Generator (Sono-Tek Corporation, Milton, N.Y., U.S.A.).

When the desired ultrasonic frequency or frequencies have been achieved at the spray head, the liquid precursor solution can be pumped to the spray head, which comprises a tip surface and a spray orifice. The liquid precursor solution can be pumped to the spray head by any one or more pumps suitable for such purpose. An example of a suitable pump includes, without limitation, a VMP TRI Pulseless “Smoothflow” pump equipped with three Q1-CSC-W-LF pump heads, available from Fluid Metering Inc. (Syosset, N.Y., U.S.A.).

The tip surface will also be ultrasonically excited, at the same frequency or frequencies as the spray head. The tip surface may be of any shape suitable for delivering atomized material to the air including, for example, conical and cylindrical. The diameter of the tip surface can vary. In some embodiments, the diameter of the tip surface ranges from about 0.1 inches to about 0.3 inches. In some embodiments, the diameter of the tip surface is selected from about 0.100 inches, 0.110 inches, 0.120 inches, 0.130 inches, 0.140 inches, 0.150 inches, 0.160 inches, 0.170 inches, 0.180 inches, 0.190 inches, 0.200 inches, 0.210 inches, 0.220 inches, 0.230 inches, 0.240 inches, 0.250 inches, 0.260 inches, 0.270 inches, 0.280 inches, 0.290 inches, and 0.300 inches. In some embodiments, the tip surface is conical and has a diameter of about 0.230 inches.

The diameter of the spray orifice can vary. In some embodiments, the diameter of the spray orifice ranges from about 0.01 inches to about 0.02 inches. In some embodiments, the diameter of the spray orifice is selected from about 0.010 inches, about 0.011 inches, about 0.012 inches, about 0.013 inches, about 0.014 inches, about 0.015 inches, about 0.016 inches, about 0.017 inches, about 0.018 inches, about 0.019 inches, and about 0.020 inches. In some embodiments, the diameter of the spray orifice is 0.015 inches. In some embodiments, the spray orifice may be fitted with one or more devices to facilitate gas-driven spray delivery of material from the orifice. In some embodiments, the spray orifice can be fitted with a device configured to deliver a controlled jet of air or other gas(es) in a desired direction. The device may be configured such that the jet of air or other gas(es) generates a fan-shaped spray pattern. The velocity of the jet of air or other gas(es) can be controlled and varied. An example of a suitable device configured to deliver a controlled jet of air or other gas(es) from the spray orifice is the Impact EDGE system available from Sono-Tek Corporation (Milton, N.Y., U.S.A.). In some embodiments, the device configured to deliver a controlled jet of air or other gas(es) from the spray orifice delivers a controlled jet of nitrogen gas.

At the spray head, standing waves of the liquid precursor solution form due to the influence of the ultrasonic frequency or frequencies. These waves become unstable at their peaks and collapse, leading to the generation of fine and/or atomized droplets of the precursor solution. The fine and/or atomized droplets of the precursor solution are delivered from the spray orifice and carried, by the jet of air delivered from the spray orifice and/or by a second controlled flow of air and/or other gas(es) to a substrate surface. To ensure that the flow of air delivering the fine and/or atomized droplets is, and remains, at a desired rate, the flow rate of the air and/or gas(es) can be monitored using any one or more devices. An example of a suitable device for monitoring the flow of air and/or other gas(es) is a Model FMA 1818 Mass Flowmeter available from Omega Engineering, Inc. (Stamford, Conn., U.S.A.).

The second controlled flow of air and/or other gas(es) may optionally be used to enhance the flow of the fine and/or atomized droplets of the precursor solution from the spray orifice to the substrate surface. The second controlled flow of air and/or other gas(es) can be any suitable gas. In some embodiments, the second controlled flow of air and/or other gas(es) is inert an does not react or otherwise interfere with the fine and/or atomized droplets of precursor solution. In some embodiments, the second controlled flow of air and/or other gas(es) is nitrogen gas. The second controlled flow of air and/or other gas(es) can be produced using any number of devices.

The substrate can be of any type suitable for receiving one or more electrochromic films onto a surface. In some embodiments, the substrate is a thin material such as, for example, a film. In some embodiments, film substrates are fluorine-doped tin oxide films. In some embodiments, the substrate is a material suitable for consumer use and commercial preparation such as, for example, glass. In some embodiments, the substrate surface can be treated prior to deposition of the fine and/or atomized precursor material. In some embodiments, the substrate surface can be cleaned prior to deposition of the fine and/or atomized precursor material. In some embodiments, the substrate surface can be cleaned with isopropanol. In some embodiments, the substrate surface can be cleaned with an isopropanol-soaked clean-room wipe, blown dry with nitrogen, and then placed in an oxygen plasma (800 mTorr, 155 watts) for 5 minutes.

The temperature of the substrate surface upon contact with the fine and/or atomized precursor solution can vary. In some embodiments, the temperature of the substrate surface upon contact with the fine and/or atomized precursor solution ranges from about ambient temperature to about 600° C. In some embodiments, the fine and/or atomized precursor solution comprises one or more starting materials, as defined above, and one or more dopants, as defined above. In such embodiments, the temperature of the substrate surface upon contact with the fine and/or atomized precursor solution is sufficiently high to thermally decompose the starting material, but not the dopant. In some embodiments, the temperature of the substrate surface upon contact with the fine and/or atomized precursor solution is sufficiently high to thermally decompose the starting material and to melt the dopant, but is not high enough to thermally decompose the dopant.

In some embodiments, the fine and/or atomized precursor solution comprises one or more starting materials, which comprise nitrates of one or more of the Group VIII transition metals, and one or more dopants, which comprise nitrates of one or more alkali metal ions. In such embodiments, the temperature of the substrate surface upon contact with the fine and/or atomized precursor solution is sufficiently high to thermally decompose the nitrates of the one or more of the Group VIII transition metals and to melt the nitrates of the one or more alkali metal ions, but is not sufficiently high to thermally decompose the nitrates of the one or more alkali metal ions.

In some embodiments: the fine and/or atomized precursor solution comprises NiNO₃ and LiNO₃ as a dopant. In such embodiments, the temperature of the substrate surface upon contact with the fine and/or atomized precursor solution is sufficiently high to thermally decompose the NiNO₃ and to melt the LiNO₃, but is not sufficiently high to thermally decompose the LiNO₃.

In some embodiments, the temperature of the substrate surface upon contact with the fine and/or atomized precursor solution ranges from about ambient temperature to about 600° C., in some embodiments from about 200° C. to about 550° C., in some embodiments from about 300° C. to about 350° C., in some embodiments from about 325° C. to about 335° C., and in some embodiments is about 330° C. In some embodiments, the temperature of the substrate surface upon contact with the fine and/or atomized precursor solution is selected from about 200° C., about 210° C., about 220° C., about 225° C., about 230° C., about 240° C., about 250° C., about 260° C., about 270° C., about 275° C., about 280° C., about 290° C., about 300° C., about 310° C., about 320° C., about 325° C., about 330° C., about 340° C., about 350° C., about 360° C., about 370° C., about 375° C., about 380° C., about 390° C., about 400° C., about 410° C., about 420° C., about 425° C., about 430° C., about 440° C., about 450° C., about 460° C., about 470° C., about 475° C., about 480° C., about 490° C., and about 500° C. In some embodiments, the temperature of the substrate surface upon contact with the fine and/or atomized precursor solution is about 330° C.

At the substrate surface, the liquid precursor solution is allowed to dry. During drying, a lattice is created on the substrate surface. The lattice may be completely crystalline, partially crystalline and partially amorphous, or completely amorphous, as described above.

### EXAMPLES

The following examples describe in detail the preparation and properties of embodiments of the electrochromic films of the present disclosure. It will be apparent to those skilled in the art that many modifications, both to materials and methods, may be practiced without departing from the scope of the disclosure.

### Example 1

The deposition chemistry of a specific starting material, nickel nitrate (NiNO₃), and a specific dopant, lithium nitrate (LiNO₃), was determined. In all of the Examples presented herein, nickel nitrate and lithium nitrate salts were obtained from Sigma Aldrich Co. (St. Louis, Mo., U.S.A.) and used as received. Thermogravimetric analysis (TGA) of both salts was performed in order to determine optimal deposition temperatures of such salts onto a substrate surface. TGA data is useful for predicting optimal deposition temperatures, even if it is not useful for predicting the exact products that will form upon deposition.

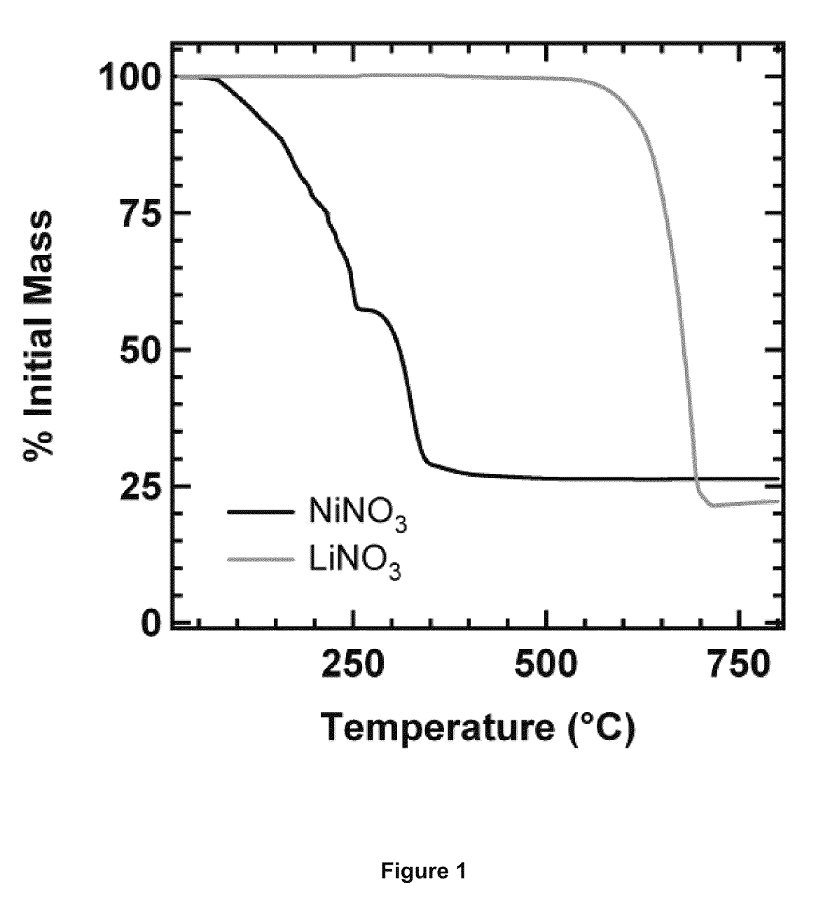

TGA data for both nickel nitrate and lithium nitrate salts collected under a “pseudo” air mixture (80% nitrogen, 20% oxygen) are shown in FIG. 1. As shown in FIG. 1, decomposition of the NiNO₃ salt appears to come to completion near about 325° C. The documented mass loss, shown at up to about 250° C., is consistent with dehydration of the starting salt material, whereas the mass loss finishing at 325° C. is consistent with the loss of the nitrate ion. The final percentage of the original mass of NiNO₃ is below what may be expected for conversion of the NiNO₃ salt to NiO under these conditions, which may indicate sub-stoichiometry in the final product.

FIG. 1 also shows TGA data for the LiNO₃ salt. As shown, LiNO₃ does not show significant mass loss until about 600° C., although differential thermal analysis confirmed a melting point for the LiNO₃ salt of about 260° C.

Based on these data, deposition of electrochromic films using NiNO₃ as a starting material and using lithium nitrate LiNO₃ as the source of the lithium ion dopant could be performed at temperatures at about 600° C. without significant mass loss of the dopant ion source. However, such elevated temperatures may cause damage to the substrate, as has been noted previously. With this in mind, it was determined to proceed with spray-coating deposition methods with the substrate temperature at about 330° C. As shown in FIG. 1, this temperature is sufficiently high to thermally decompose the NiNO₃ salt nickel nitrate and to melt the LiNO₃ salt, but not to thermally decompose the LiNO₃. It is therefore believed that spray-coating deposition of these materials at this temperature will result in the chemical products derived from the thermal decomposition of NiNO₃ existing and forming a lattice in melted, and thus liquid, non-thermally decomposed LiNO₃. It is further believed that this is important and will impart improved properties to electrochromic films comprising NiNO₃ and LiNO₃ that are deposited in this manner, as several papers have reported improved performance for ceramic materials sintered in the presence of a liquid phase.

### Example 2

Two electrochromic films were made via spray-coating deposition on glass microscope slides as described herein and using the temperature determined in Example 1. Prior to deposition, the substrates were cleaned with an isopropanol-soaked clean-room wipe, blown dry with nitrogen, and then placed in an oxygen plasma (800 mTorr, 155 watts) for 5 minutes. The first film was made by spray-depositing an aqueous NiNO₃ solution onto a glass microscope slide. The second film was made by spray-depositing an aqueous solution comprising NiNO₃ with 5 wt % LiNO₃ added. The loading level of LiNO₃ was determined based on separate experiments that demonstrated no significant improvement in performance of electrochromic films containing greater than 5 wt % LiNO₃. All solutions for spray deposition were made with deionized water.

The ultrasonic spray system utilized for deposition was from Sono-Tek Corporation (Milton, N.Y., U.S.A.) and had a Model 8700-120 spray head that operates at a frequency of 120 kHz. A Sono-Tek Corporation (Milton, N.Y., U.S.A.) Broad Band Ultrasonic Generator was used to apply ultrasonic excitation to the spray nozzle, which had a 0.230 inch diameter conical tip and a 0.015 inch diameter orifice that is fitted with the Impact System for gas-driven spray delivery. A controlled gas flow was supplied by a Model FMA 1818 Mass Flowmeter from Omega Engineering, Inc. (Stamford, Conn., U.S.A.), which delivered the atomized material to the surface. The precursor solution was pumped to the spray nozzle through a Fluid Metering Inc. (Syosset, N.Y., U.S.A.) VMP TRI Pulseless “Smoothflow” pump equipped with three Q1-CSC-W-LF pump heads.

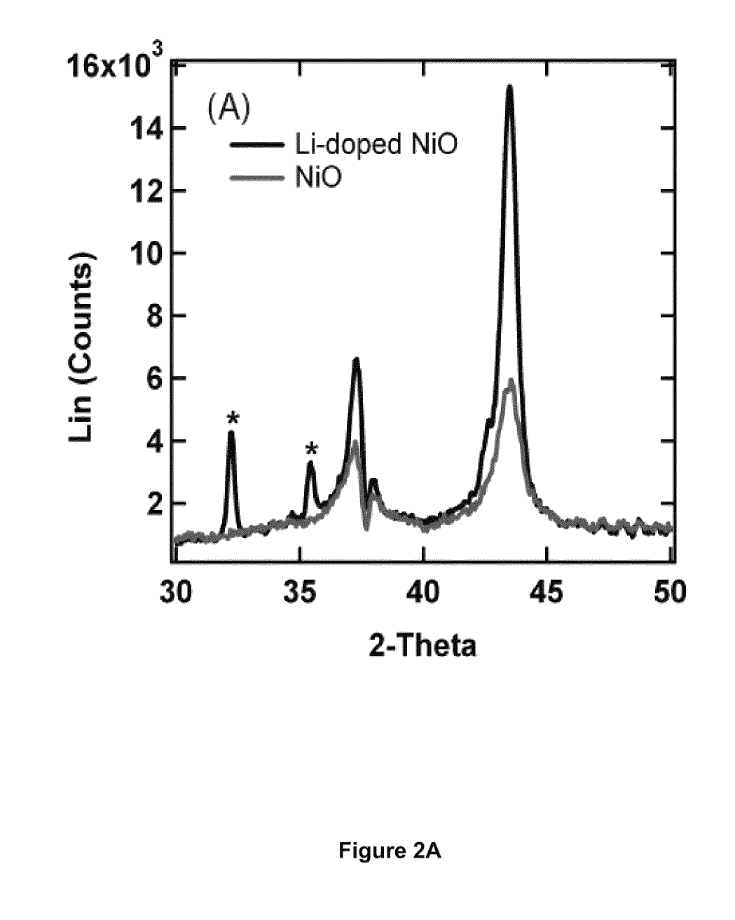

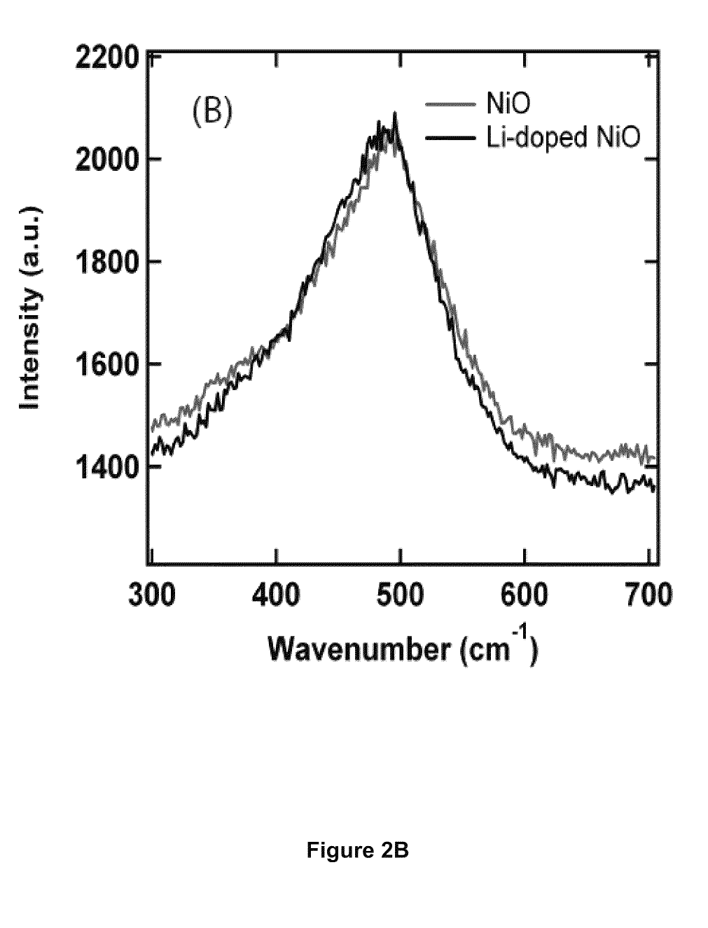

X-ray diffraction (XRD) data for both films is shown in FIG. 2A. The film sprayed from NiNO₃ clearly shows two peaks, at 37.30° (the 111 peak) and 43.50° (the 200 peak) respectively, that indicate the formation of nickel oxide (NiO), with the (200) peak being dominant. A dominant (200) peak is indicative of an electrochromic film comprising a randomly oriented crystalline lattice. XRD data for the Li-doped film shows identical peaks for NiO formation with greater intensity signals, as well as two other peaks, at 32.25° and 35.45° (denoted with an asterisk), that represent unreacted lithium nitrate. No peaks are observed that can be correlated to previously reported LiNiO crystal structures.

XRD data were collected using a Bruker AXS D8 Discover with a HiStar area detector, available from Bruker AXS (Madison, Wis., U.S.A.). For XRD measurements, the sample was illuminated with x-rays from a copper target (40 kV, 35 mA) using a Göebel mirror and 1 mm circular collimator. The XRD signals contain both Kα1 and Kα2 components, but no Kβ component as it was filtered out by the Göebel mirror. The two-dimensional area detector data was integrated in chi using GADDS software (Spectral Solutions, Solna, Sweden) to produce a more conventional XRD intensity versus two theta data plot.

Raman spectroscopy data for both films is shown in FIG. 2B. The spectra of both the NiO and lithium-doped NiO films exhibited a single wavenumber peak at about 500 cm⁻¹, which is consistent with previously reported excitation of the NiO stretching vibrations. No shift in wavenumber is observed upon adding lithium ions to the film.

Raman spectra were collected using 2.54 eV (488 nm) laser excitation. Back-scattered light was analyzed with a Jobin Yvon 270M spectrometer equipped with a liquid nitrogen-cooled Spectrum One charge-coupled device (CCD) and a holographic notch filter. A Nikon 55-mm camera lens (Nikon Corporation, Melville, N.Y., U.S.A.) was employed both to focus the beam on the sample to a ˜0.25 mm² spot and to collect the Raman scattered light. Averaging three 60 second scans was sufficient to obtain high-intensity, well-resolved Raman spectra.

As discussed below, lithium-doped NiO electrochromic films spray-deposited as described herein display improved electrochromic performance. This fact, combined with the XRD and Raman data, suggests that both amorphous LiNiO and NiO crystallites are present in the lithium-doped NiO electrochromic films disclosed herein.

### Example 3

Two electrochromic films were made via spray-coating deposition on fluorine-doped tin oxide films as described herein and using the temperature determined in Example 1. Prior to deposition, the substrates were cleaned with an isopropanol-soaked clean-room wipe, blown dry with nitrogen, and then placed in an oxygen plasma (800 mTorr, 155 watts) for 5 minutes. The first film was made by spray-depositing an aqueous NiNO₃ solution onto a fluorine-doped tin oxide film. The second film was made by spray-depositing an aqueous solution comprising NiNO₃ with 5 wt % LiNO₃ added. The loading level of LiNO₃ was determined as described in Example 2. The ultrasonic spray system utilized for deposition was as described for Example 2. Both films were spray-deposited to approximately the same thickness.

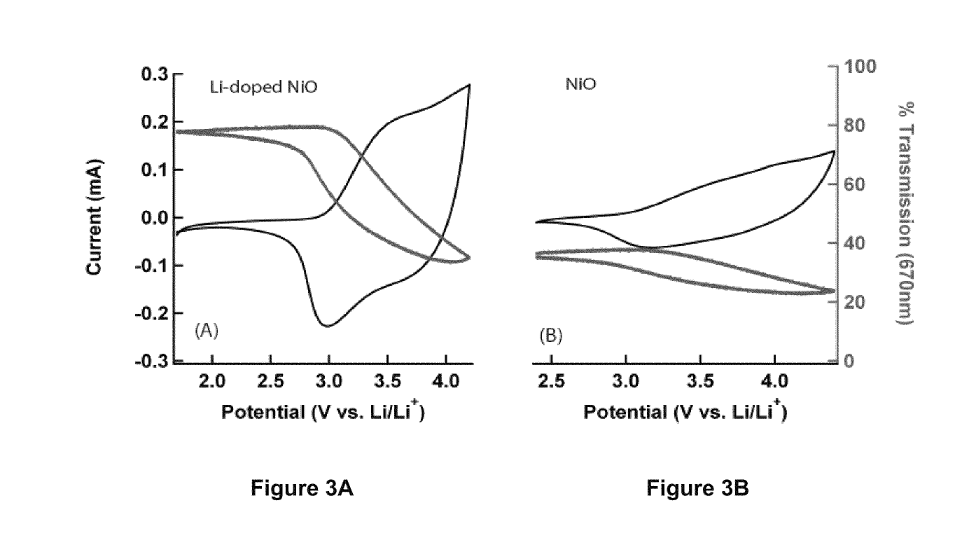

The electrochromic performance of both films was determined. FIG. 3A shows cyclic voltammetry coupled with optical transmission data collected at 670 nm for the lithium-doped NiO electrochromic film. FIG. 3B shows cyclic voltammetry coupled with optical transmission data collected at 670 nm for the undoped NiO electrochromic film. Although both films were sprayed to approximately the same thickness, the lithium-doped NiO film clearly shows both higher charge insertion upon cycling and, subsequently, a larger transmission change. The voltammetry for the lithium-doped NiO film also shows more-defined peaks for lithium intercalation and de-intercalation as compared to the undoped NiO film. The better-defined peaks and more rapid increase in current as a function of potential indicates a larger and faster ion intercalation into the lithium-doped NiO film as compared to the undoped NiO film.

Cyclic voltammetry and potential cycling measurements were made using a BioLogic (Knoxville, Tenn., U.S.A.) VMP3 multichannel potentiostat. Samples were examined in a two-electrode testing mode versus a lithium metal counter electrode in 1M lithium perchlorate dissolved in propylene carbonate. All electrochemical testing was performed inside a controlled atmosphere glovebox from Vacuum Atmospheres Corporation (Hawthorne, Calif., U.S.A.). All voltammetric scans were collected at a 20 mV/s scan rate and all electrodes tested were 1 cm² in geometric surface area. Pre-made electrolyte solutions for electrochemical testing were obtained from Ferro Corporation (Zachary, La., USA).

### Example 4

The two electrochromic films, one made from an aqueous NiNO₃ solution and another made from an aqueous solution comprising NiNO₃ with 5 wt % LiNO₃, made for the testing presented in Example 3 were used again in this Example.

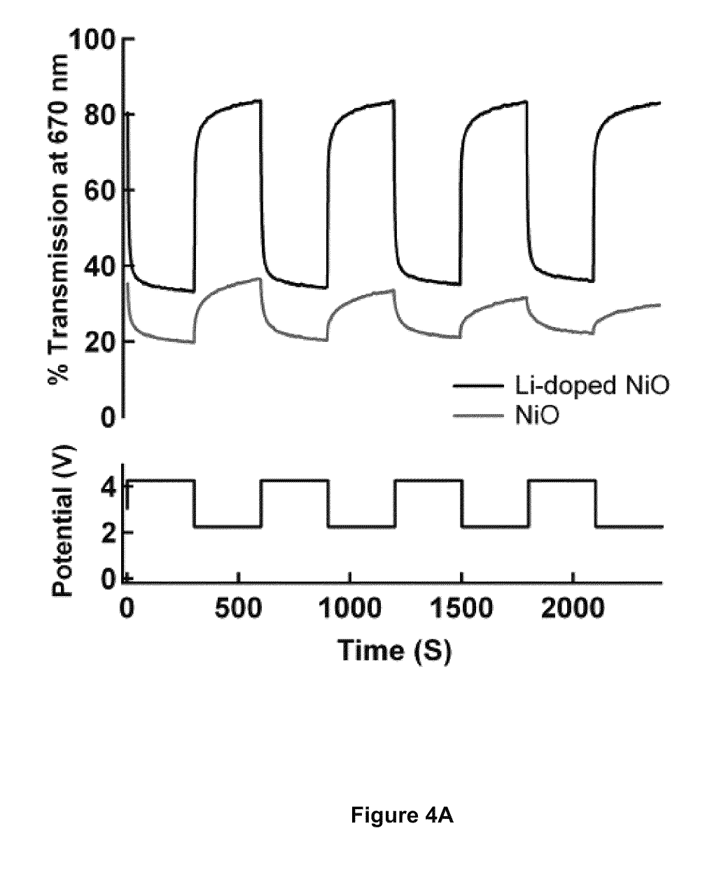

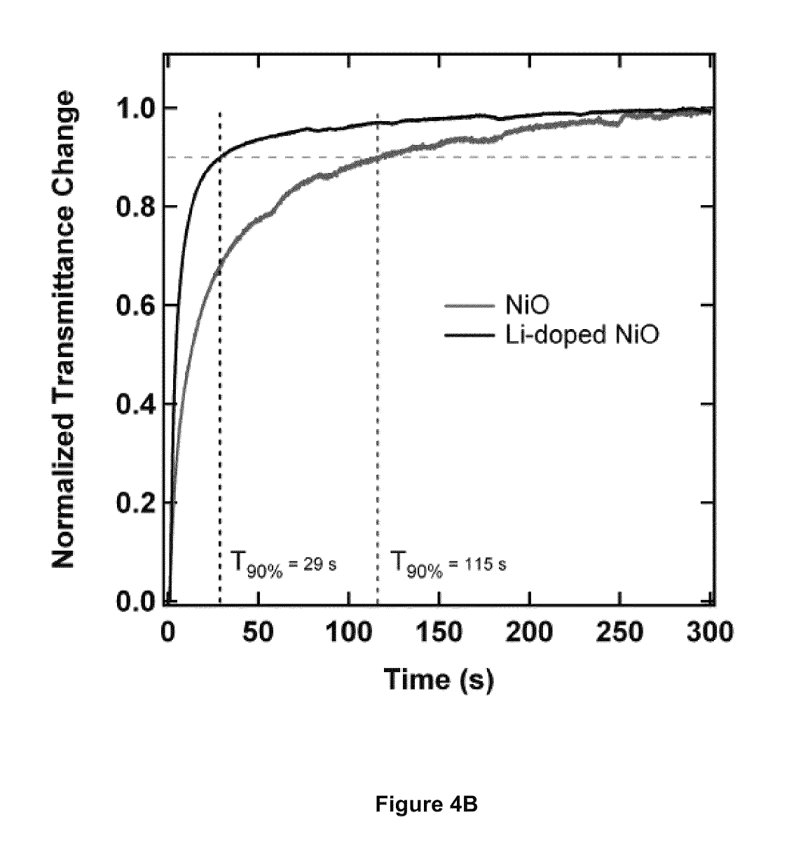

Optical transmission data for both films under potential step cycling from 2.25 V to 4.25 V vs. Li/Li⁺ is shown in FIG. 4A. The lithium-doped NiO film shows a significantly higher transmission modulation, of from about 83% to about 33%, than the transmission modulation of the undoped NiO film, which was from about 36% to about 19%. These values are slightly different from those observed in Example 3 due to longer times (5 min) spent at potential extremes than were employed for the voltammetric scans.

Coloration efficiency (CE) is one of the most important metrics for selecting an electrochromic material. CE is defined as the change in optical density (OD) per unit inserted charge (Q), i.e., CE=ΔOD/ΔQ. Analysis of the data for the lithium-doped NiO film yields a CE of 33 cm²/C, which is comparable to that measured for sputtered films.

As can be seen in FIG. 4A, the transmission modulation of the undoped NiO film degrades over time, even in such a limited number of potential cycles. In contrast, the lithium-doped NiO film shows cycling stability, thus representing an improvement over the undoped NiO film. However, in longer-term cycling (>50 cycles) a decrease in transmission modulation for the lithium-doped NiO films was observed.

In addition to the larger transmission change, the lithium-doped NiO film displays faster coloration change than the undoped NiO film. This is demonstrated clearly in FIG. 4B, which shows normalized transmission data for the lithium-doped NiO film versus the undoped NiO film. The normalizing data are those reported for coloration of undoped NiO-based devices, where the switching speed is reported as the time to achieve 90% of the total coloration change. As can be seen, the undoped NiO film shows a typical slow coloration process, reaching 90% of its color change in about 115 seconds. In contrast, the lithium-doped NiO film achieved 90% of its color change in about 29 seconds and displayed a significantly larger change in transmission. Similar measurements for the bleaching step showed that the lithium-doped NiO film bleached in about 57 seconds. These color switching speeds are comparable to those reported for WO₃ films. This demonstrates that lithium-doped NiO electrochromic films can be used as counter-electrodes in electrochromic devices employing WO₃ films as active electrodes.

In-situ optical transmission measurements employed a diode laser operating at 670 nm as the source and a Thorlabs, Inc. (Newton, N.J., U.S.A.) DET100A Large Area Silicon Detector. Clean, uncoated, FTO substrates were used to set the 100% transmission level of the detector prior to obtaining sample measurements.

### Example 5

The effect of the surface morphology of the film on electrochromic color changes was observed. An advantage of a spray-deposition process that uses aqueous-based liquid precursor materials is the ability to adjust the formulation being atomized and deposited. For example, a lower concentration of precursor material per drop of atomized liquid may lead to smaller crystallite sizes upon drying.

The effect of surface morphology on the performance of electrochromic films was determined by varying the concentrations of the salts used in the liquid precursor materials. Electrochromic films were made via spray-coating deposition on fluorine-doped tin oxide films as described in Example 3.

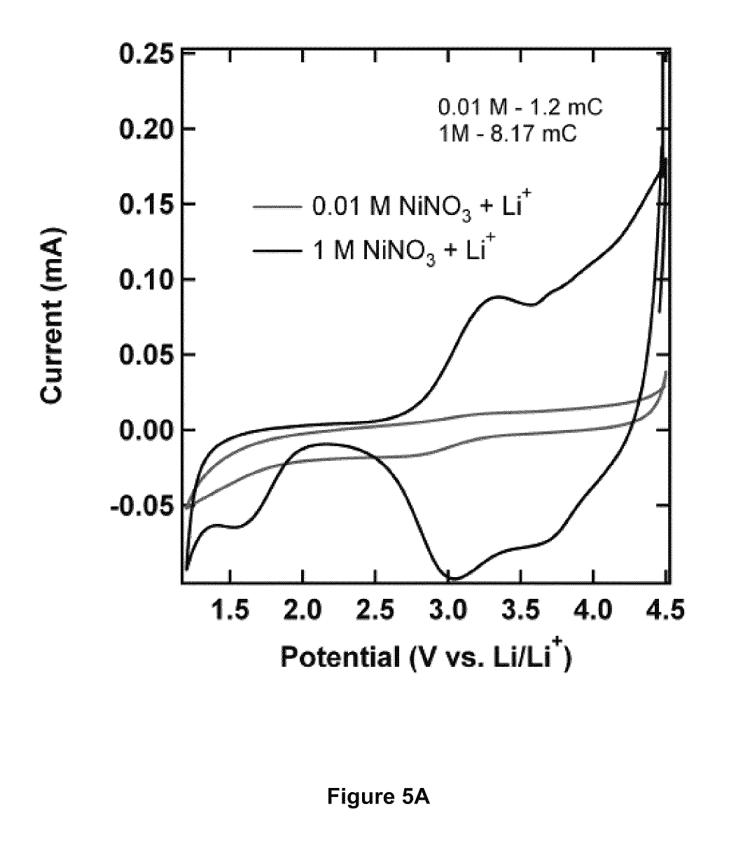

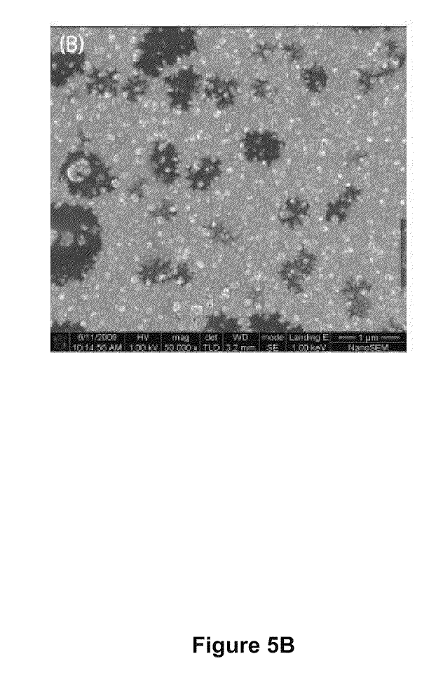

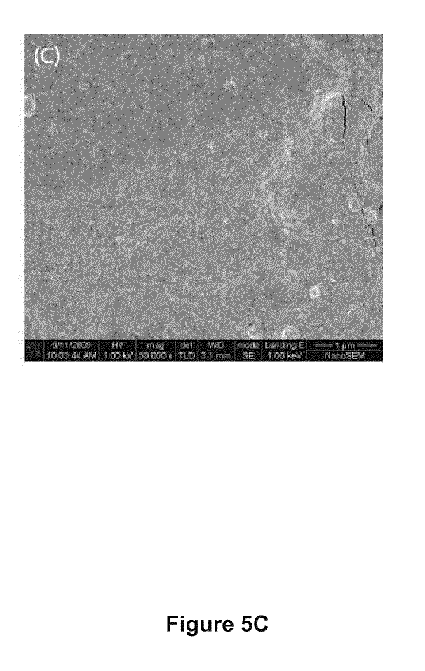

Several electrochromic films were made using an aqueous solution comprising NiNO₃ with 5 wt % LiNO₃, and the concentration of the NiNO₃ was varied. In one film, the concentration of the NiNO₃ was 10 mM. In another film the concentration of the NiNO₃ was 1 M. Both films had 5 wt % LiNO₃ added. Films were spray coated to identical thickness by varying the number of coats based on the solution concentration. For example, only a single coating was deposited with the 1 M NiNO₃ concentration, whereas the sample from 10 mM NiNO₃ concentration required 100 coatings to obtain the same thickness. FIG. 5A shows cyclic voltammetry data collected for these films. The film deposited from the 1 M NiNO₃ precursor solution shows higher charge injection than the film deposited from the 10 mM NiNO₃ precursor solution.

The scanning electron microscope (SEM) images on the right correspond to the voltammetric results. The top image (FIG. 5B) is of the film deposited from the 10 mM NiNO₃ precursor solution, and the bottom image (FIG. 5C) is for the film deposited from the 1 M NiNO₃ precursor solution. Phase separation is clearly evident for the 10 mM NiNO₃ film; the 1 M NiNO₃ film appears significantly more uniform and does not show phase separation. This observation can be explained by taking into account the total time required for each deposition process. The attempt to maintain the same final film thickness while changing the precursor concentration led to excessively long deposition times for the 10 mM sample (about 60 minutes). The longer exposure to the elevated substrate temperature (about 330° C.) resulted in annealing of the film, causing phase separation and particle agglomeration. In contrast, the 1 M film was deposited in under 60 seconds and clearly yields superior performance.

### Example 6

Lithium-doped NiO films have application in dye-sensitized solar cells and optoelectronics and thermal devices. In all instances, the lithium ion source is lithium chloride (LiCl), not lithium nitrate. The advantages of lithium-doped NiO films having LiNO₃ as the source of the lithium ion dopant is set forth in the preceding Examples. To determine whether LiCl may have the same, or a different, effect on a NiO film, the difference in electrochromic performance between an undoped NiO film and a lithium-doped NiO film having LiCl as the source of the lithium ion dopant, was determined.

Two electrochromic films were made via spray-coating deposition on fluorine-doped tin oxide films as described in Example 3. The first film was made by spray-depositing an aqueous solution of NiNO₃ onto a fluorine-doped tin oxide film. The second film was made by spray-depositing an aqueous solution comprising NiNO₃ with 5 wt % LiCl added. The ultrasonic spray system utilized for deposition was as described for Example 2. Both films were spray-deposited to approximately the same thickness.

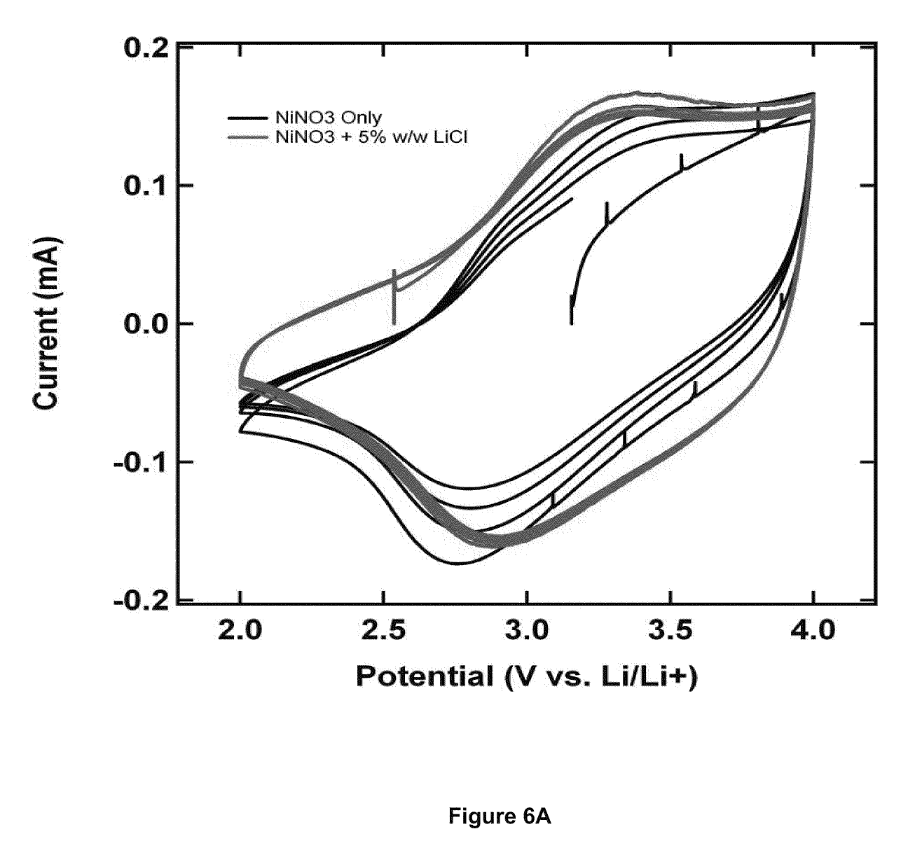

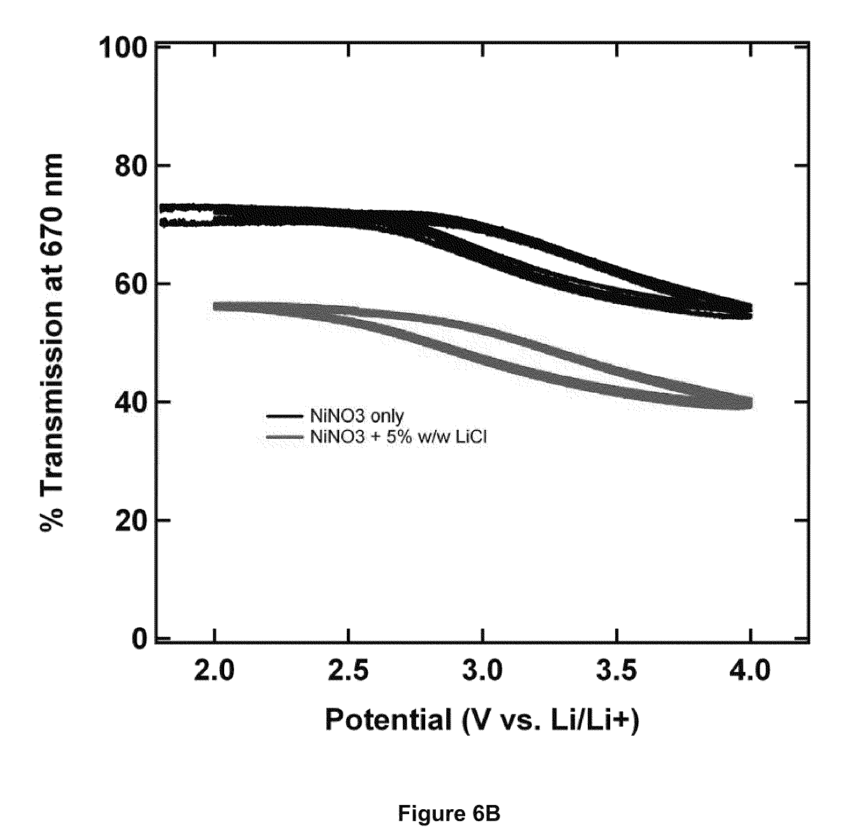

The electrochromic performance of both films was determined. Cyclic voltammetry and potential cycling measurements were made as described in Example 3. FIGS. 6A and 6B show cyclic voltammetry coupled with optical transmission data collected at 670 nm for the undoped NiO film as compared to the lithium-doped NiO electrochromic film having LiCl as the lithium ion source. As can be seen, there is no statistical difference between undoped NiO film and the lithium-doped NiO film having LiCl as the lithium ion source. The data indicates a similar ion intercalation into the lithium-doped NiO film having LiCl as the lithium ion source as compared to the undoped NiO film. The results indicate a clear advantage to using lithium-doped NiO films having LiNO₃ as the source of the lithium ion dopant over lithium-doped NiO films having LiCl as the source of the lithium ion dopant. It is apparent that using LiCl as the lithium ion source in films used in electrochromic applications does not provide any change in electrochromic performance over undoped NiO films.

Finally, it should be noted that there are alternative ways of implementing the embodiments disclosed herein. While a number of exemplary aspects and embodiments have been discussed above, those of skill in the art will recognize certain modifications, permutations, additions and sub combinations thereof. Accordingly, the present embodiments are to be considered as illustrative and not restrictive. Furthermore, the claims are not to be limited to the details given herein, and are entitled their full scope and equivalents thereof.

What is claimed is:

1. An electrochromic film comprising a lattice of an oxide of a Group VIII transition metal and a dopant deposited onto the surface of a substrate;
wherein the oxide is generated by heating at least one starting material and at least one dopant ion source on the surface of the substrate.

2. The electrochromic film of claim 1, wherein the oxide is selected from iron oxide, cobalt oxide, nickel oxide, ruthenium oxide, rhodium oxide, palladium oxide, osmium oxide, iridium oxide, platinum oxide and combinations of the foregoing.

3. The electrochromic film of claim 1, wherein the dopant comprises hydrogen ions, lithium ions, sodium ions, potassium ions, rubidium ions, caesium ions, francium ions, and combinations of the foregoing.

4. The electrochromic film of claim 1, wherein the heating is performed at a temperature of from 300° C. to 350° C.

5. The electrochromic film of claim 1, wherein the at least one starting material is selected from iron nitrate, cobalt nitrate, nickel nitrate, ruthenium nitrate, rhodium nitrate, palladium nitrate, osmium nitrate, iridium nitrate, platinum nitrate and combinations thereof.

6. The electrochromic film of claim 1, wherein the at least one starting material is nickel nitrate.

7. The electrochromic film of claim 1, wherein the at least one dopant ion source is selected from nitric acid, lithium nitrate, sodium nitrate, potassium nitrate, rubidium nitrate, caesium nitrate, francium nitrate, and combinations thereof.

8. The electrochromic film of claim 1, wherein the at least one dopant ion source is lithium nitrate.

9. The electrochromic film of claim 1, wherein the at least one starting material is nickel nitrate and the at least one dopant ion source is lithium nitrate.

10. The electrochromic film of claim 9, wherein the heating is performed at 330° C.

11. The electrochromic film of claim 1, wherein the lattice is selected from completely crystalline, completely amorphous, and partially amorphous.

12. The electrochromic film of claim 11, wherein the lattice is partially amorphous and comprises crystallites of the oxide of the Group VIII transition metal.

13. The electrochromic film of claim 1, wherein the film colors anodically.

14. A method of making an electrochromic film, comprising:
introducing a precursor solution, comprising at least one starting material and at least one dopant ion source, into an ultrasonic spray deposition system comprising a spray head, wherein the spray head comprises a tip surface and a spray orifice;
applying an ultrasonic frequency to the spray head to ultrasonically excite the tip surface;
pumping the precursor solution to the ultrasonically excited tip surface;
generating standing waves in the liquid precursor solution on the tip surface;
generating atomized droplets of the liquid precursor solution at the tip surface;
moving the atomized droplets from the spray orifice to a heated substrate surface by a controlled flow of gas;
heating the atomized droplets on the substrate surface to generate the electrochromic film.

15. The method of claim 14, wherein the at least one starting material is selected from iron nitrate, cobalt nitrate, nickel nitrate, ruthenium nitrate, rhodium nitrate, palladium nitrate, osmium nitrate, iridium nitrate, platinum nitrate and combinations thereof.

16. The method claim 14, wherein the at least one dopant ion source is selected from nitric acid, lithium nitrate, sodium nitrate, potassium nitrate, rubidium nitrate, caesium nitrate, francium nitrate, and combinations thereof.

17. The method of claim 14, wherein the ultrasonic frequency is from 110 kHz to 130 kHz.

18. The method of claim 14, wherein the gas in the controlled flow of gas is nitrogen.

19. The method of claim 14, wherein the at least one starting material is nickel nitrate, the at least one dopant ion source is lithium nitrate, and the heating is performed at 330° C.

20. An electrochromic film comprising a lithium ion-doped nickel oxide lattice deposited onto the surface of a substrate;
wherein the nickel oxide is generated by heating 95 wt % nickel nitrate and 5 wt % lithium nitrate to 330° C. on the surface of the substrate;
wherein the lattice comprises an amorphous lithium-nickel-oxide matrix comprising nickel oxide crystallites; and
wherein the film colors anodically.
